(19) United States
(12) Patent Application Publication
(10) Pub. No.: US 2020/0094168 A1
(43) Pub. Date: Mar. 26, 2020

(54) OIL SEPARATING DEVICE AND VACUUM DIE CASTING APPARATUS

(71) Applicant: TOYOTA JIDOSHA KABUSHIKI KAISHA, Toyota-shi (JP)

(72) Inventors: Minoru SAWAFUJI, Toyota-shi (JP); Toshiki FUJIKAWA, Toyota-shi (JP)

(73) Assignee: TOYOTA JIDOSHA KABUSHIKI KAISHA, Toyota-shi (JP)

(21) Appl. No.: 16/525,741

(22) Filed: Jul. 30, 2019

(30) Foreign Application Priority Data
Sep. 25, 2018 (JP) 2018-178566

(51) Int. Cl. B01D 19/00; B22D 17/14; B22D 17/20

(52) U.S. Cl. CPC B01D 19/0042; B22D 17/32; B22D 17/2038; B22D 17/14

(57) ABSTRACT

An oil separating device is provided in an intake path through which a cavity of a mold and an intake port of a vacuum pump communicate with each other and the oil separating device is configured to separate oil from a combustion gas flowing through the intake path. The oil separating device includes a first tubular body and a spiral plate accommodated in the first tubular body. The spiral plate and the first tubular body define a spiral flow path.

### INCORPORATION BY REFERENCE

The disclosure of Japanese Patent Application No. 2018-178566 filed on Sep. 25, 2018 including the specification, drawings and abstract is incorporated herein by reference in its entirety.

### BACKGROUND

### 1. Technical Field

The present disclosure relates to an oil separating device and a vacuum die casting apparatus.

### 2. Description of Related Art

As one of metal mold casting methods, a die casting method in which molten metal is forcibly inserted into a mold and with which a cast can be manufactured at a high dimensional precision in a short time has been known. In the case of the die casting method, there is a possibility of a defect due to air entrapment or a mold corner portion not filled with molten metal since the molten metal is forcibly inserted into the mold at a high speed. Therefore, a vacuum die casting method, in which molten metal is injected to fill a mold after air present in a cavity in the mold is sucked by a vacuum pump in advance such that the pressure in the cavity is reduced and the cavity enters a vacuum state, has been proposed. In the case of the vacuum die casting method, the flowability of the molten metal is improved and running properties are improved since resistance is small. In addition, since a gas is sucked out from the cavity, a casting defect called a blow hole or blister which is caused by gas entrapment is also suppressed.

In many of such die casting apparatuses, lubricant is supplied into an injection sleeve through a molten metal supply port before molten metal is poured such that the movement of a plunger tip in the injection sleeve is improved. A component of the lubricant is, for example, any of oxidized polyethylene, vegetable oil wax, graphite wax, alkamide, silicon wax, and solid lubricant or a combination thereof.

Japanese Unexamined Patent Application Publication No. 11-057968 (JP 11-057968 A) discloses a configuration in which a filter is provided in an intake path through which a vacuum die casting apparatus and a vacuum pump communicate with each other. The filter is provided with a filtering medium formed of steel wool. Foreign substances such as metal powder generated in the vacuum die casting apparatus are collected by the filtering medium of the filter.

### SUMMARY

Meanwhile, when lubricant is supplied into an injection sleeve, the lubricant is combusted due to the heat of the injection sleeve and a combustion gas is generated. The generated combustion gas is sucked by a vacuum pump via a cavity. Here, oil contained in the combustion gas has a property of being likely to adhere and accumulate since the oil becomes highly adhesive when there is a decrease in pressure and temperature. In a case where the oil adheres to a pressure reducing system or the like and accumulates thereon, there is a possibility that the degree of cavity pressure reduction is deteriorated.

Collecting the oil in the combustion gas is not mentioned in JP 11-057968 A.

The present disclosure provides an oil separating device that is provided in an intake path, through which a cavity in a vacuum die casting apparatus and an intake port of a vacuum pump communicate with each other, and that separates oil from a gas flowing through the intake path and a vacuum die casting apparatus.

A first aspect of the present disclosure relates to an oil separating device. The oil separating device is provided in an intake path through which a cavity of a mold and an intake port of a vacuum pump communicate with each other and the oil separating device is configured to separate oil from a gas flowing through the intake path. The oil separating device includes a first tubular body and a spiral plate accommodated in the first tubular body. The spiral plate and the first tubular body define a spiral flow path.

According to the first aspect of the present disclosure, it is possible to separate the oil from the gas since the oil contained in the gas is collected by the first tubular body and the spiral plate due to an inertial force.

In the oil separating device according to the first aspect, the spiral plate may be configured to be inserted into and extracted from the first tubular body.

According to the first aspect of the present disclosure, it is possible to easily recover oil adhering to the first tubular body and the spiral plate.

The oil separating device according to the first aspect may further include a second tubular body and a plurality of baffle plates accommodated in the second tubular body. The baffle plates may be arranged in a longitudinal direction of the second tubular body and the second tubular body and the baffle plates may define a zigzag flow path.

According to the first aspect of the present disclosure, it is possible to separate oil from the gas since the oil contained in the gas is collected by the baffle plates due to an inertial force.

In the oil separating device according to the first aspect, the second tubular body may be a rectangular tubular body, the second tubular body may be provided with a first side plate and a second side plate facing each other, one of two baffle plates adjacent to each other in the longitudinal direction of the second tubular body may be fixed to the first side plate, the other of the two baffle plates adjacent to each other in the longitudinal direction of the second tubular body may be fixed to the second side plate, and the first side plate and the second side plate may be configured to be attached to and detached from each other.

According to the first aspect of the present disclosure, it is possible to easily recover oil adhering to the two adjacent baffle plates since the two adjacent baffle plates are separated from each other when the first side plate is detached from the second side plate.

In the oil separating device according to the first aspect, each of the baffle plates may be provided with a ventilation portion and the ventilation portions of two baffle plates adjacent to each other in the longitudinal direction of the second tubular body may be disposed at different positions as seen in the longitudinal direction of the second tubular body.

According to the first aspect of the present disclosure, the zigzag flow path is formed with a simple configuration.

In the oil separating device according to the first aspect, two baffle plates adjacent to each other in the longitudinal direction of the second tubular body may be configured to become closer to each other toward a downstream side of a flow path defined by the two baffle plates.

According to the first aspect of the present disclosure, it is possible to make the flow speed of the gas greater toward a downstream side of a flow path defined by the two baffle plates.

The oil separating device according to the first aspect may further include a second baffle plate that is disposed between two baffle plates adjacent to each other in the longitudinal direction of the second tubular body and divides a space defined by the two baffle plates.

According to the first aspect of the present disclosure, a flow path defined by the two baffle plates becomes more complicated.

A second aspect of the present disclosure relates to a vacuum die casting apparatus including a mold, a vacuum pump, an intake path, and an oil separating device.

A cavity of the mold and an intake port of the vacuum pump communicate with each other through the intake path and the oil separating device is configured to separate oil from a gas flowing through the intake path. The oil separating device is disposed in the intake path. The oil separating device includes a first tubular body and a spiral plate accommodated in the first tubular body and the spiral plate and the first tubular body define a spiral flow path in the oil separating device.

According to the aspects of the present disclosure, it is possible to separate oil from a gas flowing through an intake path with an oil separating device provided in the intake path through which a cavity of a vacuum die casting apparatus and an intake port of a vacuum pump communicate with each other.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic view illustrating the entire vacuum die casting apparatus;

FIG. 2 is a perspective view of an oil separating device partially cut out;

FIG. 3 is a perspective view of the oil separating device in which a front surface panel is not shown;

FIG. 4 is an exploded perspective view of a helical trap;

FIG. 5 is an enlarged view of part A in FIG. 3;

FIG. 6 is a perspective view of the oil separating device in which the front surface panel is not shown;

FIG. 7 is a perspective view of the oil separating device in which the front surface panel is not shown and which illustrates a flow path of a combustion gas;

FIG. 8 is a contour diagram illustrating flow speed distribution in the oil separating device;

FIG. 9 is a view illustrating lines of flow in the oil separating device;

FIG. 10 is a view for describing a performance test of the oil separating device;

FIG. 11 is a photograph of a rag with which oil collected in the helical trap has been wiped out; and

FIG. 12 is a photograph of a pipe on a downstream side of the oil separating device.

### DETAILED DESCRIPTION OF EMBODIMENTS

Hereinafter, a preferred embodiment of the present disclosure will be described.

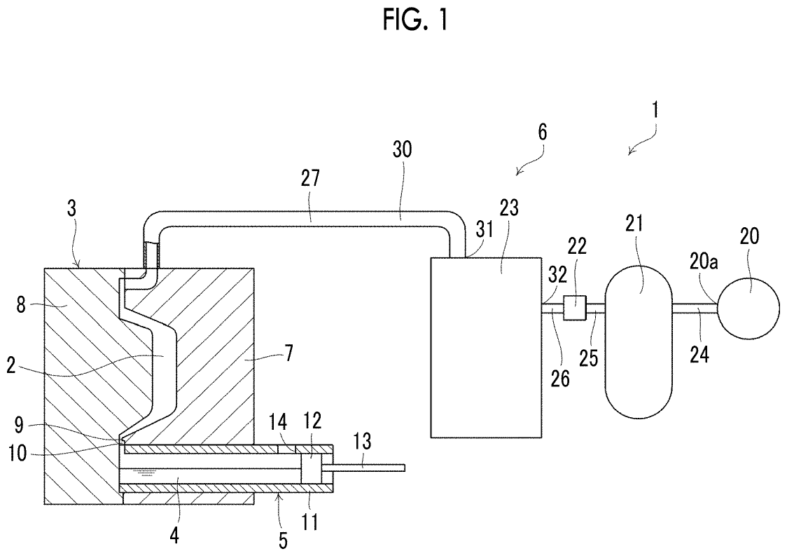

FIG. 1 illustrates a vacuum die casting apparatus 1. The vacuum die casting apparatus 1 is provided with a mold 3 having a cavity 2, an injection device 5 that injects molten metal 4 into the cavity 2, and a vacuum suction device 6 that vacuum-sucks a gas in the cavity 2.

The mold 3 includes a fixed mold 7 and a movable mold 8. When the mold 3 is clamped, the cavity 2 is formed between the fixed mold 7 and the movable mold 8. In addition, a gate 9 and a runner 10 are formed in the mold 3 when the mold 3 is in a clamped state.

The injection device 5 includes an injection sleeve 11, a plunger tip 12, a rod 13, and plunger driving means (not shown).

The injection sleeve 11 communicates with the runner 10 of the mold 3 and is coupled to the fixed mold 7. A molten metal supply port 14 for pouring the molten metal 4 into the injection sleeve 11 is formed in a rear end of the injection sleeve 11.

The plunger tip 12 is disposed in the injection sleeve 11 such that the plunger tip 12 can freely move forward and backward inside the injection sleeve 11 along a longitudinal direction of the injection sleeve 11. A lubricant that improves sliding between the injection sleeve 11 and the plunger tip 12 is applied onto an outer peripheral surface of the plunger tip 12. A component of the lubricant is, for example, any of oxidized polyethylene, vegetable oil wax, graphite wax, alkamide, silicon wax, and solid lubricant or a combination thereof.

The plunger driving means drives the plunger tip 12 via the rod 13 connected to the plunger tip 12 such that the plunger tip 12 moves forward and backward.

The vacuum suction device 6 includes a vacuum pump 20, a vacuum tank 21, a pressure reducing valve 22, and an oil separating device 23.

The vacuum pump 20 and the vacuum tank 21 communicate with each other through a pipe 24.

The vacuum tank 21 and the pressure reducing valve 22 communicate with each other through a pipe 25.

The pressure reducing valve 22 and the oil separating device 23 communicate with each other through a pipe 26.

The oil separating device 23 and the cavity 2 of the mold 3 communicate with each other through a pipe 27.

The pipe 24, the pipe 25, the pipe 26, and the pipe 27 constitute an intake path 30 through which the cavity 2 of the mold 3 and an intake port 20a of the vacuum pump 20 communicate with each other. Accordingly, it is possible to say that the oil separating device 23 is provided in the intake path 30.

The oil separating device 23 is a device that separates oil from a gas flowing through the intake path 30. The configuration of the oil separating device 23 will be described in detail later.

In the case of the above-described configuration, a negative pressure is supplied from the vacuum tank 21 to the cavity 2 when the pressure reducing valve 22 is opened.

Next, an operation of the vacuum die casting apparatus 1 will be schematically described.

First, the lubricant is applied to the outer peripheral surface of the plunger tip 12. Next, a predetermined amount of molten metal 4 is poured into the injection sleeve 11 through the molten metal supply port 14. Then, the plunger tip 12 is driven to move forward. When the plunger tip 12 moves forward beyond the position of the molten metal supply port 14, the pressure reducing valve 22 is opened such that a gas in the cavity 2 is vacuum-sucked. Then, the plunger tip 12 is caused to move further forward such that the molten metal 4 is injected into the cavity 2 through the runner 10 and the gate 9.

At this time, the lubricant applied onto the outer peripheral surface of the plunger tip 12 is combusted due to the heat of the molten metal 4. Therefore, a combustion gas containing oil is generated in the plunger tip 12. The combustion gas in the plunger tip 12 is sucked by the vacuum suction device 6 and is guided to the oil separating device 23 through the cavity 2 and the pipe 27. Then, the oil contained in the combustion gas is separated from the combustion gas by the oil separating device 23 and is collected by the oil separating device 23. Accordingly, the pipe 26, the pressure reducing valve 22, the pipe 25, the vacuum tank 21, the pipe 24, and the vacuum pump 20 which are disposed downstream of the oil separating device 23 can be kept clean.

Next, the oil separating device 23 will be described in detail.

As shown in FIG. 1, the oil separating device 23 is provided with an intake port 31 that communicates with the cavity 2 of the mold 3 and an exhaust port 32 that communicates with the pressure reducing valve 22.

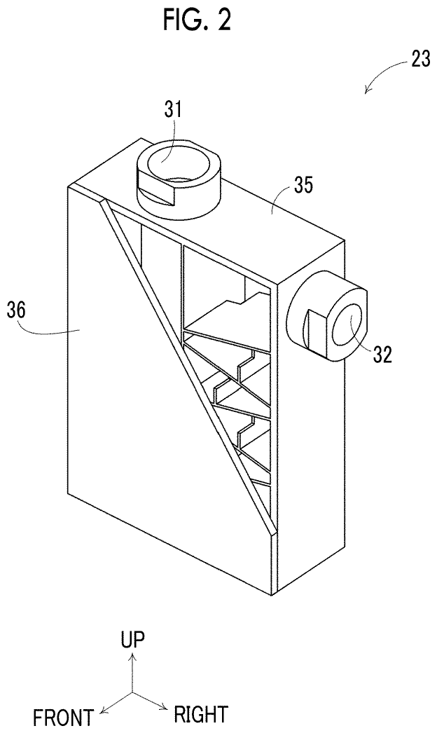

FIG. 2 is a perspective view of the oil separating device 23. In the following description of the oil separating device 23, terms “upper side”, “lower side”, “front side”, “rear side”, “right side”, and “left side” will be used. A direction to the upper side is a direction opposite to a direction to the lower side. A direction to the front side is a direction opposite to a direction to the rear side. A direction to the right side is a direction opposite to a direction to the left side. The direction to the upper side, the direction to the front side, and the direction to the right side are orthogonal to each other.

The direction to the upper side is a specific example of a first direction. The direction to the lower side is a specific example of a second direction. The direction to the front side is a specific example of a third direction. The direction to the rear side is a specific example of a fourth direction. The direction to the right side is a specific example of a fifth direction. The direction to the left side is a specific example of a sixth direction.

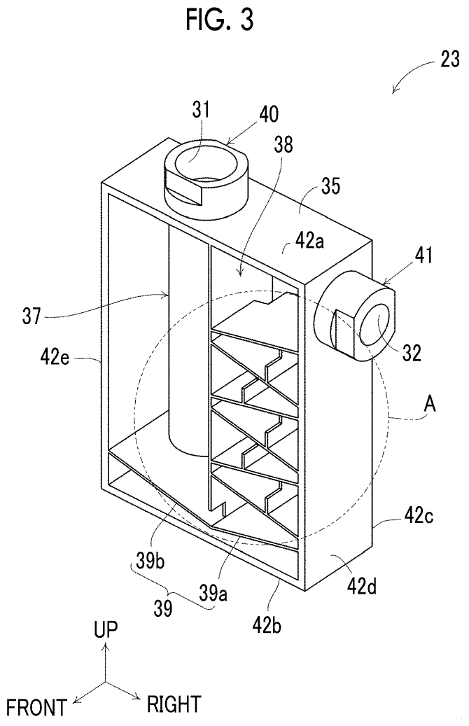

As shown in FIGS. 2 and 3, the oil separating device 23 has a rectangular parallelepiped shape and includes a box body 35 open to a front side, a front surface panel 36 that blocks an opening of the box body 35, a helical trap 37, a labyrinth trap 38, a V-shaped bottom plate 39, an intake port side joint 40, and an exhaust port side joint 41.

As shown in FIG. 3, the box body 35 includes a top plate 42a, a bottom plate 42b, a rear plate 42c, a right side plate 42d, and a left side plate 42e. The intake port 31 is formed in a left portion of the top plate 42a and the left portion of the top plate 42a is provided with the intake port side joint 40 such that the intake port side joint 40 communicates with the intake port 31. The exhaust port 32 is formed in an upper portion of the right side plate 42d and the upper portion of the right side plate 42d is provided with the exhaust port side joint 41 such that the exhaust port side joint 41 communicates with the exhaust port 32.

The front surface panel 36 shown in FIG. 2 is configured to be able to be attached to and detached from the opening of the box body 35 via a fastening member such as a screw.

As shown in FIG. 3, the helical trap 37 (helix-shaped oil separating unit), the labyrinth trap 38 (labyrinth-shaped oil separating unit), and the V-shaped bottom plate 39 are accommodated in an internal space of the box body 35.

The helical trap 37 is disposed on a left side of the internal space of the box body 35. The labyrinth trap 38 is disposed on a right side of the internal space of the box body 35. The V-shaped bottom plate 39 is disposed on a lower side of the internal space of the box body 35.

### V-shaped Bottom Plate 39

The V-shaped bottom plate 39 includes a right inclined plate 39a that is downwardly inclined toward a left side from the right side plate 42d and a left inclined plate 39b that is downwardly inclined toward a right side from the left side plate 42e. That is, the V-shaped bottom plate 39 extends from the right side plate 42d to the left side plate 42e and is folded to protrude downward.

### Helical Trap 37

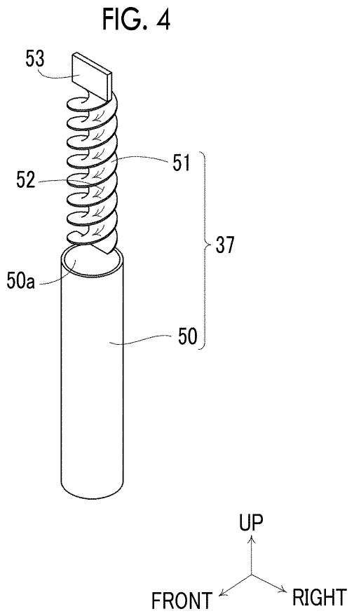

As shown in FIGS. 3 and 4, the helical trap 37 is disposed to extend in a vertical direction. As shown in FIG. 4, the helical trap 37 is provided with a tubular body 50 having a hollow cylindrical shape and a spiral plate 51 accommodated in the tubular body 50. Since the spiral plate 51 is accommodated in the tubular body 50, an inner circumferential surface 50a of the tubular body 50 and the spiral plate 51 form a spiral flow path 52, as a flow path having a spiral shape. In addition, an upper end of the tubular body 50 communicates with the intake port 31 shown in FIG. 3. Accordingly, the combustion gas sucked into the oil separating device 23 through the intake port 31 spirally flows downward at a high speed in the spiral flow path 52 of the helical trap 37. At this time, the particle sizes of droplets of oil contained in the combustion gas fall within a range of 1 to 10 micrometers and each of the oil droplets is very light. However, the oil contained in the combustion gas spirally flows at a high speed and thus is strongly pressed against the inner circumferential surface 50a of the tubular body 50. Therefore, the oil adheres to the inner circumferential surface 50a of the tubular body 50 and is collected.

Note that, the spiral plate 51 has good maintenance properties since the spiral plate 51 is configured to be able to be inserted into and extracted from the tubular body 50. In addition, when a positioning plate 53 provided at an upper end of the spiral plate 51 is engaged with the intake port side joint 40, the position of the spiral plate 51 relative to the tubular body 50 in a longitudinal direction of the tubular body 50 is determined.

### Labyrinth Trap 38

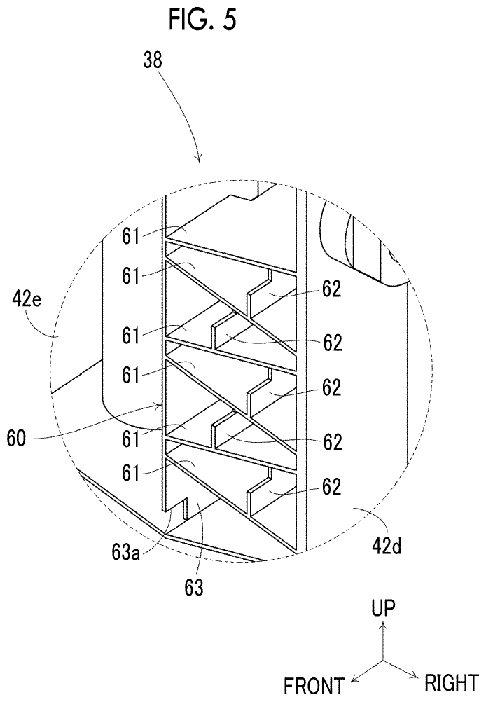

As shown in FIG. 5, the labyrinth trap 38 is disposed to extend in the vertical direction. The labyrinth trap 38 includes a tubular body 60 having a hollow rectangular tubular shape, a plurality of baffle plates 61 accommodated in the tubular body 60, and a plurality of perpendicular baffle plates 62 accommodated in the tubular body 60.

The tubular body 60 is formed by the right side plate 42d, a right portion of the rear plate 42c (refer to FIG. 3 together), a right portion of the front surface panel 36 (refer to FIG. 2 together), and a central partition wall 63. The central partition wall 63 is disposed between the right side plate 42d and the left side plate 42e and is a flat plate parallel to the right side plate 42d and the left side plate 42e. A cutout 63a is formed in a lower front end of the central partition wall 63. The combustion gas discharged from the helical trap 37 is introduced into the labyrinth trap 38 through the cutout 63a, flows in a zigzag shape in the labyrinth trap 38, and is discharged through the exhaust port 32.

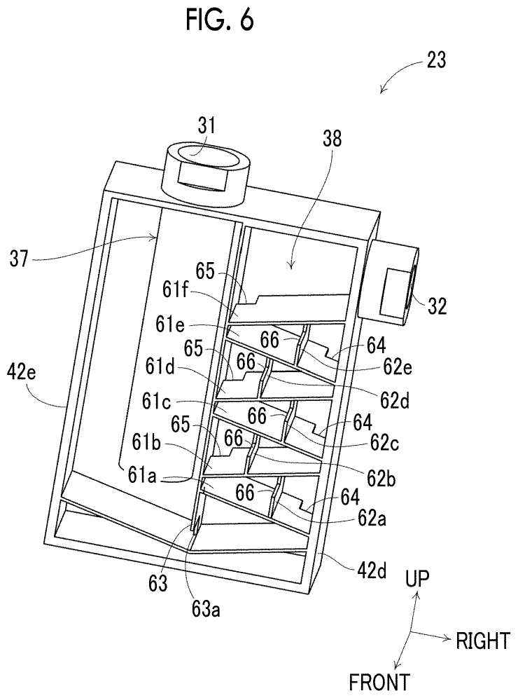

The horizontal baffle plates 61 are arranged at approximately equal intervals in the vertical direction. The horizontal baffle plates 61 extend to the right side plate 42d from the central partition wall 63. The horizontal baffle plates 61 and the perpendicular baffle plates 62 are alternately arranged in the vertical direction. Hereinafter, for the sake of convenience of the description, the horizontal baffle plates 61 will be referred to as horizontal baffle plates 61a, 61b, 61c, 61d, 61e, 61f in order from the bottom to the top as shown in FIG. 6. Similarly, the perpendicular baffle plates 62 will be referred to as perpendicular baffle plates 62a, 62b, 62c, 62d, 62e in order from the bottom to the top.

The perpendicular baffle plate 62a is disposed between the horizontal baffle plate 61a and the horizontal baffle plate 61b.

The perpendicular baffle plate 62b is disposed between the horizontal baffle plate 61b and the horizontal baffle plate 61c.

The perpendicular baffle plate 62c is disposed between the horizontal baffle plate 61c and the horizontal baffle plate 61d.

The perpendicular baffle plate 62d is disposed between the horizontal baffle plate 61d and the horizontal baffle plate 61e.

The perpendicular baffle plate 62e is disposed between the horizontal baffle plate 61e and the horizontal baffle plate 61f.

The baffle plates 61a, 61c, 61e are flat plates that are downwardly inclined toward a right side. Meanwhile, the horizontal baffle plates 61b, 61d, 61f are flat plates that are upwardly inclined toward the right side.

A cutout 64 is formed in a right rear end of each of the horizontal baffle plates 61a, 61c, 61e. Similarly, a cutout 65 is formed in a left rear end of each of the horizontal baffle plates 61b, 61d, 61f.

The perpendicular baffle plate 62a is a flat plate parallel to the right side plate 42d and extends to the horizontal baffle plate 61b from the horizontal baffle plate 61a. The perpendicular baffle plate 62a is disposed to divide a space between the horizontal baffle plate 61a and the horizontal baffle plate 61b in a lateral direction. A cutout 66 is formed in a front upper end of the perpendicular baffle plate 62a.

The perpendicular baffle plate 62b is a flat plate parallel to the right side plate 42d and extends to the horizontal baffle plate 61c from the horizontal baffle plate 61b. The perpendicular baffle plate 62b is disposed to divide a space between the horizontal baffle plate 61b and the horizontal baffle plate 61c in the lateral direction. The cutout 66 is formed in a front upper end of the perpendicular baffle plate 62b.

The perpendicular baffle plate 62c is a flat plate parallel to the right side plate 42d and extends to the horizontal baffle plate 61d from the horizontal baffle plate 61c. The perpendicular baffle plate 62c is disposed to divide a space between the horizontal baffle plate 61c and the horizontal baffle plate 61d in the lateral direction. The cutout 66 is formed in a front upper end of the perpendicular baffle plate 62c.

The perpendicular baffle plate 62d is a flat plate parallel to the right side plate 42d and extends to the horizontal baffle plate 61e from the horizontal baffle plate 61d. The perpendicular baffle plate 62d is disposed to divide a space between the horizontal baffle plate 61d and the horizontal baffle plate 61e in the lateral direction. The cutout 66 is formed in a front upper end of the perpendicular baffle plate 62d.

The perpendicular baffle plate 62e is a flat plate parallel to the right side plate 42d and extends to the horizontal baffle plate 61f from the horizontal baffle plate 61e. The perpendicular baffle plate 62e is disposed to divide a space between the horizontal baffle plate 61e and the horizontal baffle plate 61f in the lateral direction. The cutout 66 is formed in a front upper end of the perpendicular baffle plate 62e.

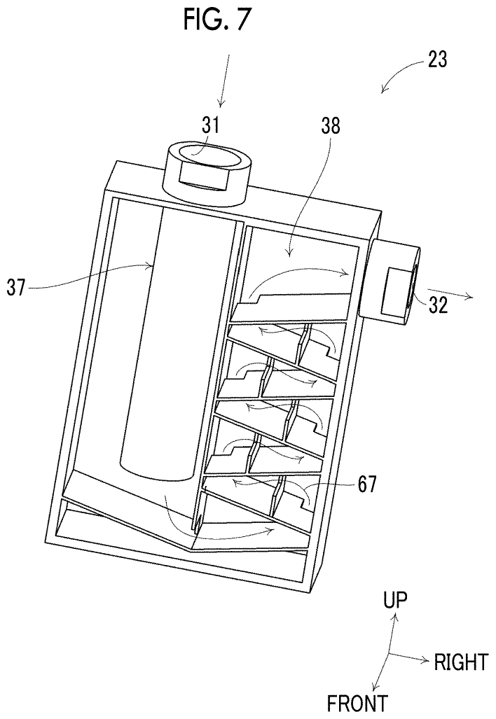

In the case of the above-described configuration, as illustrated in FIG. 7, a zigzag flow path 67 as a zigzag flow path is formed in the labyrinth trap 38. Specifically, as illustrated in FIGS. 6 and 7, the combustion gas flowing in the zigzag flow path 67 passes through the zigzag flow path 67 in an order from (1) to (7) as follows.

(1) The combustion gas discharged from the helical trap 37 flows into the labyrinth trap 38 through the cutout 63a of the central partition wall 63.

(2) The combustion gas passes through the cutout 64 of the horizontal baffle plate 61a and the cutout 66 of the perpendicular baffle plate 62a in this order and flows to the left side.

(3) The combustion gas passes through the cutout 65 of the horizontal baffle plate 61b and the cutout 66 of the perpendicular baffle plate 62b in this order and flows to the right side.

(4) The combustion gas passes through the cutout 64 of the horizontal baffle plate 61c and the cutout 66 of the perpendicular baffle plate 62c in this order and flows to the left side.

(5) The combustion gas passes through the cutout 65 of the horizontal baffle plate 61d and the cutout 66 of the perpendicular baffle plate 62d in this order and flows to the right side.

(6) The combustion gas passes through the cutout 64 of the horizontal baffle plate 61e and the cutout 66 of the perpendicular baffle plate 62e in this order and flows to the left side.

(7) The combustion gas passes through the cutout 65 of the horizontal baffle plate 61f, flows to the right side, and is discharged through the exhaust port 32.

In addition, the combustion gas passing through the cutout 64 of the horizontal baffle plate 61a collides with a lower surface of the horizontal baffle plate 61b due to an inertial force. Due to the above-described collision, oil contained in the combustion gas adheres to the lower surface of the horizontal baffle plate 61b and is collected.

Similarly, the combustion gas passing through the cutout 65 of the horizontal baffle plate 61b collides with a lower surface of the horizontal baffle plate 61c due to an inertial force. Due to the above-described collision, oil contained in the combustion gas adheres to the lower surface of the horizontal baffle plate 61c and is collected.

Similarly, the combustion gas passing through the cutout 64 of the horizontal baffle plate 61c collides with a lower surface of the horizontal baffle plate 61d due to an inertial force. Due to the above-described collision, oil contained in the combustion gas adheres to the lower surface of the horizontal baffle plate 61d and is collected.

Similarly, the combustion gas passing through the cutout 65 of the horizontal baffle plate 61d collides with a lower surface of the horizontal baffle plate 61e due to an inertial force. Due to the above-described collision, oil contained in the combustion gas adheres to the lower surface of the horizontal baffle plate 61e and is collected.

Similarly, the combustion gas passing through the cutout 64 of the horizontal baffle plate 61e collides with a lower surface of the horizontal baffle plate 61f due to an inertial force. Due to the above-described collision, oil contained in the combustion gas adheres to the lower surface of the horizontal baffle plate 61f and is collected.

In this manner, the combustion gas repeatedly collides with the horizontal baffle plates 61 in the zigzag flow path 67 of the labyrinth trap 38. Accordingly, oil contained in the combustion gas is effectively collected by the labyrinth trap 38.

In addition, since the perpendicular baffle plates 62 are provided in addition to the horizontal baffle plates 61, the combustion gas repeatedly collides with the perpendicular baffle plates 62 as well. Accordingly, oil contained in the combustion gas is more effectively collected by the labyrinth trap 38.

In addition, the cutout 64 or the cutout 65 formed in each horizontal baffle plate 61 is formed in the rear end of each horizontal baffle plate 61. Meanwhile, the cutout 66 formed in each perpendicular baffle plate 62 is formed in the front end of each perpendicular baffle plate 62. Therefore, the zigzag flow path 67 is a complicated flow path that is zigzag in the lateral direction and is zigzag in a front-rear direction. Accordingly, the number of times of collision between the combustion gas and the labyrinth trap 38 is increased and thus the oil collecting performance of the labyrinth trap 38 is significantly improved.

### Fluid Analysis

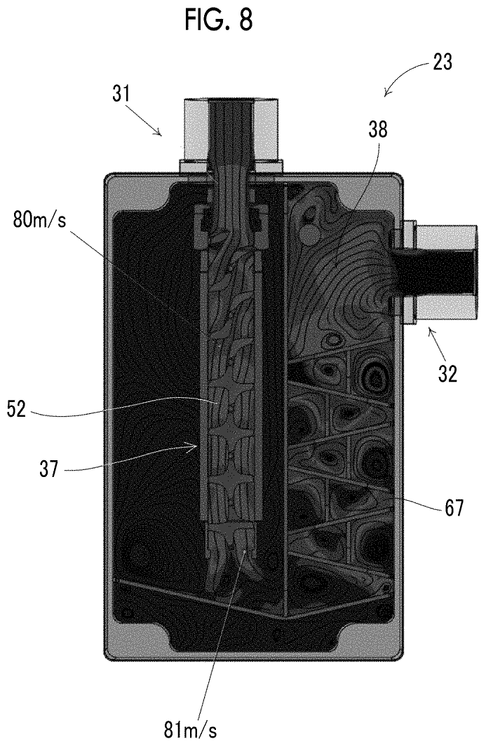

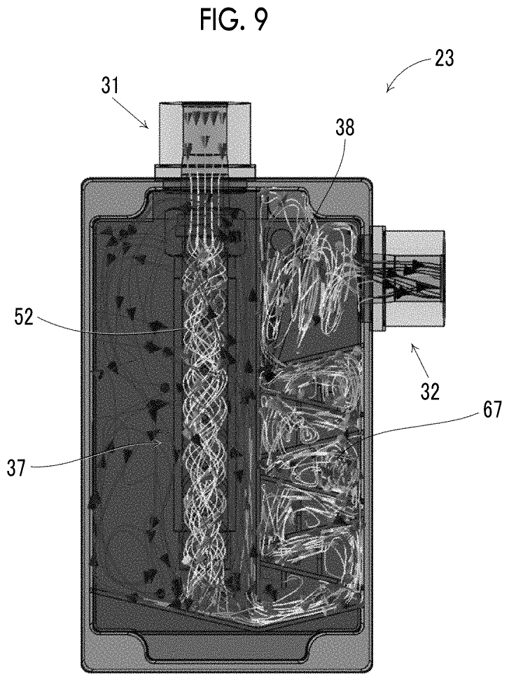

The helical trap 37 and the labyrinth trap 38 as described above are configured to actively cause the collision of the combustion gas by using the flow speed of the combustion gas. Therefore, the flow speed of the combustion gas in the oil separating device 23 is a significant factor for a collecting performance of the oil separating device 23. Therefore, the present inventors carried out fluid analysis (Computational Fluid Dynamics (CFD)) of the combustion gas in the oil separating device 23. FIG. 8 shows flow speed distribution of the combustion gas in the oil separating device 23 by means of shades of a color and FIG. 9 illustrates the lines of flow of the combustion gas in the oil separating device 23. FIGS. 8 and 9 show the result of analysis at a time point when the average flow speed of the combustion gas in the oil separating device 23 becomes maximum after the start of vacuum suction. According to FIG. 8, it can be found that it is possible to secure a flow speed of approximately 80 m/s in the spiral flow path 52 and the zigzag flow path 67. In addition, according to FIG. 9, it can be found that a desired spiral stream is formed in the spiral flow path 52 and a desired zigzag stream is formed in the zigzag flow path 67.

### Performance Test

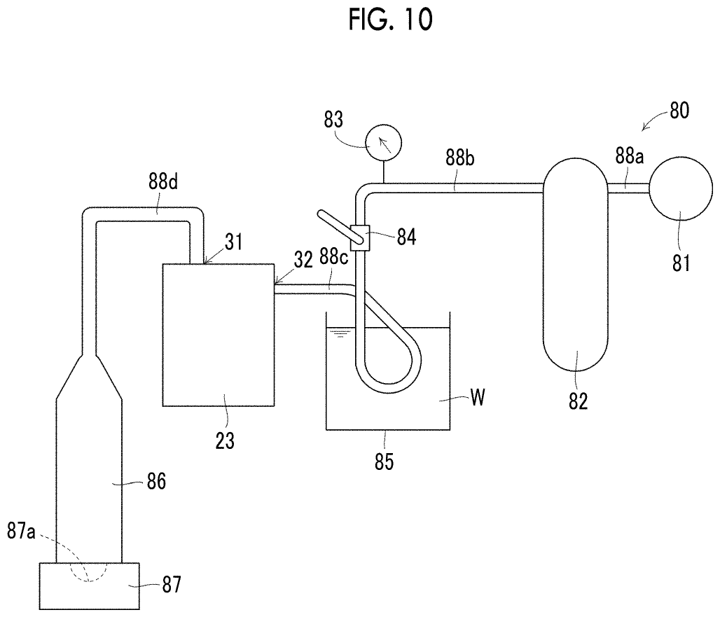

Next, a performance test of the oil separating device 23 will be reported. FIG. 10 illustrates a performance testing machine 80 for the oil separating device 23. The performance testing machine 80 is provided with a vacuum pump 81, a vacuum tank 82, a pressure gauge 83, a ball valve 84, a water tank 85, the oil separating device 23, a rocket-shaped tubular body 86, and a mold 87.

The vacuum pump 81 is connected to the vacuum tank 82 via a pipe 88a. The vacuum tank 82 is connected to the ball valve 84 via a pipe 88b. The ball valve 84 is connected to the exhaust port 32 of the oil separating device 23 via a pipe 88c. The intake port 31 of the oil separating device 23 is connected to the rocket-shaped tubular body 86 via a pipe 88d.

In addition, the pipe 88b is provided with the pressure gauge 83. The pipe 88c is a translucent flexible pipe having a diameter of 25 millimeters. A portion of the pipe 88c is immersed in a coolant W in the water tank 85. The coolant W is maintained at a temperature of 10° C. or less. A semi-spherical recess portion 87a having a radius of 40 millimeters is formed on an upper surface of the mold 87. Note that, the capacity of the vacuum tank 82 is 30 liters.

With the above-described configuration prepared, first, the vacuum pump 81 is activated such that the gauge pressure of the vacuum tank 82 becomes equal to or lower than −96 kilopascals. Next, 0.5 grams of solid lubricant is placed on the recess portion 87a of the mold 87. Next, 50 grams of molten metal 4 (680° C.) of aluminum alloy (ADC12) is poured into the recess portion 87a of the mold 87. Accordingly, the solid lubricant is ignited and combusted and the recess portion 87a is covered with the rocket-shaped tubular body 86 to extinguish a fire. In this state, the ball valve 84 is opened for approximately three seconds and is closed thereafter. Then, a semi-spherical aluminum alloy is extracted from the recess portion 87a and a carbide remaining in the recess portion 87a is wiped out or the like to clean the recess portion 87a. A step from an operation of placing the solid lubricant on the recess portion 87a and to an operation of cleaning the recess portion 87a as described above was repeated 20 times.

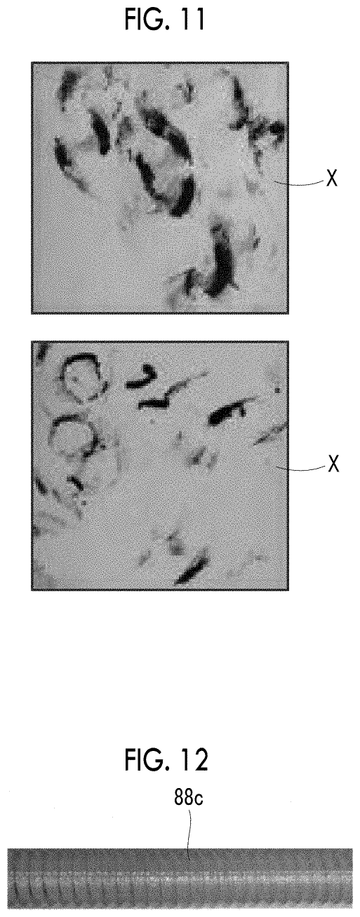

FIG. 11 illustrates a rag X that was used when wiping out oil adhering to the spiral plate 51 of the helical trap 37 of the oil separating device 23 after the above-described step was finished. According to FIG. 11, it can be understood that oil in the combustion gas was collected in the helical trap 37.

FIG. 12 illustrates the pipe 88c that was extracted from the coolant W in the water tank 85 after the above-described step was finished. According to FIG. 12, no oil adhered to the pipe 88c. Accordingly, it can be found that the oil collecting performance of the oil separating device 23 is sufficient.

Hereinabove, a preferred embodiment of the present disclosure has been described. The embodiment has features as follows.

As shown in FIGS. 1 to 4, the oil separating device 23 is provided in the intake path 30 through which the cavity 2 of the mold 3 and the intake port 20a of the vacuum pump 20 communicate with each other and the oil separating device 23 separates oil from the combustion gas flowing through the intake path 30. As shown in FIG. 4, the oil separating device 23 is provided with the tubular body 50 (first tubular body) and the spiral plate 51 accommodated in the tubular body 50. The spiral flow path 52 is formed by the tubular body 50 and the spiral plate 51. With the above-described configuration, it is possible to separate oil from the combustion gas since the oil contained in the combustion gas is collected by the tubular body 50 and the spiral plate 51 due to an inertial force.

In addition, the spiral plate 51 is configured to be able to be inserted into and extracted from the tubular body 50. With the above-described configuration, it is possible to easily recover oil adhering to the tubular body 50 and the spiral plate 51 by extracting the spiral plate 51 from the tubular body 50.

In addition, as shown in FIGS. 5 to 7, the oil separating device 23 is further provided with the tubular body 60 (second tubular body) and the horizontal baffle plates 61 (baffle plates) that are accommodated in the tubular body 60 and are arranged in the longitudinal direction of the tubular body 60. The zigzag flow path 67 is formed by the tubular body 60 and the horizontal baffle plates 61. With the above-described configuration, it is possible to separate oil from the combustion gas since the oil contained in the combustion gas is collected by the horizontal baffle plates 61 due to an inertial force.

In addition, as shown in FIGS. 2 to 7, the tubular body 60 is a rectangular tubular body and is provided with the front surface panel 36 (first side plate) and the rear plate 42c (second side plate) facing each other. In addition, one of two horizontal baffle plates 61 adjacent to each other in the longitudinal direction of the tubular body 60 is fixed to the front surface panel 36 and the other of the two horizontal baffle plates 61 is fixed to the rear plate 42c. The front surface panel 36 and the rear plate 42c are configured to be able to be attached to and detached from each other. With the above-described configuration, it is possible to easily recover oil adhering to two adjacent horizontal baffle plates 61 since the two adjacent horizontal baffle plates 61 are separated from each other when the front surface panel 36 is detached from the rear plate 42c (box body 35).

Note that, a configuration in which one of two perpendicular baffle plates 62 adjacent to each other in the longitudinal direction of the tubular body 60 is fixed to the front surface panel 36 and the other of the two perpendicular baffle plates 62 is fixed to the rear plate 42c may also be adopted. With the above-described configuration, it is possible to easily recover oil adhering to two adjacent perpendicular baffle plates 62 since the two adjacent perpendicular baffle plates 62 are separated from each other when the front surface panel 36 is detached from the rear plate 42c (box body 35).

In the present embodiment, the horizontal baffle plate 61a, the perpendicular baffle plate 62b, the horizontal baffle plate 61c, the perpendicular baffle plate 62d, and the horizontal baffle plate 61e are fixed to the front surface panel 36 and the other horizontal baffle plates 61 and perpendicular baffle plates 62 are fixed to the rear plate 42c. With the above-described configuration, it is possible to easily recover oil adhering to two adjacent horizontal baffle plates 61 and two adjacent perpendicular baffle plates 62 since the two adjacent horizontal baffle plates 61 are separated from each other and the two adjacent perpendicular baffle plates 62 are separated from each other when the front surface panel 36 is detached from the rear plate 42c (box body 35).

In addition, as shown in FIG. 6, the cutout 64 or the cutout 65 as a ventilation portion is formed in each of the horizontal baffle plates 61. The cutout 64 and the cutout 65 of two horizontal baffle plates 61 adjacent to each other in the longitudinal direction of the tubular body 60 are formed at different positions as seen in the longitudinal direction of the tubular body 60. With the above-described configuration, the zigzag flow path 67 as shown in FIG. 7 is formed with a simple configuration.

In addition, as shown in FIG. 6, two horizontal baffle plates 61 adjacent to each other in the longitudinal direction of the tubular body 60 are configured to become closer to each other toward a downstream side of a flow path defined by the two horizontal baffle plates 61. With the above-described configuration, it is possible to make the flow speed of the combustion gas greater toward a downstream side of a flow path defined by two horizontal baffle plates 61. Accordingly, for example, the combustion gas passing through the cutout 65 of the horizontal baffle plate 61b collides with the lower surface of the horizontal baffle plate 61c at a high speed and thus oil in the combustion gas adheres to the lower surface of the horizontal baffle plate 61c and is collected effectively.

In addition, as shown in FIG. 6, the perpendicular baffle plate 62 (second baffle plate) that divides a space defined by two horizontal baffle plates 61 is provided between the two horizontal baffle plates 61 that are adjacent to each other in the longitudinal direction of the tubular body 60. With the above-described configuration, a flow path defined by two horizontal baffle plates 61 becomes more complicated.

The vacuum die casting apparatus 1 is provided with the mold 3, the vacuum pump 20, and the oil separating device 23. According to the above-described configuration, it is possible to keep the vacuum pump 20 clean since oil in the combustion gas is collected in the oil separating device 23.

In the above-described embodiment, all of the box body 35, the front surface panel 36, the helical trap 37, the labyrinth trap 38, and the V-shaped bottom plate 39 are configured by using a metal plate which is excellent in corrosion resistance.

In addition, the present inventors consider that the helical trap 37 exhibits the collecting performance when the flow rate of the combustion gas is relatively small and the labyrinth trap 38 exhibits the collecting performance when the flow rate of the combustion gas is relatively large.

Hereinabove, the preferred embodiment of the present disclosure has been described. The embodiment can be modified as follows.

For example, an inner circumferential surface of the intake port 31 of the oil separating device 23 may be configured to become narrower toward a lower side and a baffle plate with which the combustion gas from the intake port 31 collides may be provided. In this case, since the combustion gas collides with the baffle plate at a high speed, oil in the combustion gas is effectively collected by the baffle plate.

In addition, the vacuum die casting apparatus 1 may be further provided with a heater that heats the pipe 27 shown in FIG. 1. With the above-described configuration, it is possible to suppress oil in the combustion gas adhering to an inner circumferential surface of the pipe 27.

In addition, the vacuum die casting apparatus 1 may be further provided with cooling means for cooling the oil separating device 23. With the above-described configuration, since oil in the combustion gas becomes highly adhesive in the oil separating device 23, the oil collecting performance of the oil separating device 23 is improved.

In addition, in FIG. 3, the helical trap 37 or the labyrinth trap 38 may be formed of material such as resin which is high in lipophilicity or the helical trap 37 or the labyrinth trap 38 may be subject to a surface treatment such that the lipophilicity thereof is improved.

What is claimed is:

1. An oil separating device provided in an intake path through which a cavity of a mold and an intake port of a vacuum pump communicate with each other, the oil separating device being configured to separate oil from a gas flowing through the intake path, the oil separating device comprising:
a first tubular body; and
a spiral plate accommodated in the first tubular body,
wherein the spiral plate and the first tubular body define a spiral flow path.

2. The oil separating device according to claim 1, wherein the spiral plate is configured to be inserted into and extracted from the first tubular body.

3. The oil separating device according to claim 1, further comprising:
a second tubular body; and
a plurality of baffle plates accommodated in the second tubular body, wherein:
the baffle plates are arranged in a longitudinal direction of the second tubular body; and
the second tubular body and the baffle plates define a zigzag flow path.

4. The oil separating device according to claim 3, wherein:
the second tubular body is a rectangular tubular body;
the second tubular body is provided with a first side plate and a second side plate facing each other;
one of two baffle plates adjacent to each other in the longitudinal direction of the second tubular body is fixed to the first side plate;
the other of the two baffle plates adjacent to each other in the longitudinal direction of the second tubular body is fixed to the second side plate; and
the first side plate and the second side plate are configured to be attached to and detached from each other.

5. The oil separating device according to claim 3, wherein:
each of the baffle plates is provided with a ventilation portion; and
the ventilation portions of two baffle plates adjacent to each other in the longitudinal direction of the second tubular body are disposed at different positions as seen in the longitudinal direction of the second tubular body.

6. The oil separating device according to claim 5, wherein two baffle plates adjacent to each other in the longitudinal direction of the second tubular body are configured to become closer to each other toward a downstream side of a flow path defined by the two baffle plates.

7. The oil separating device according to claim 3, further comprising a second baffle plate that is disposed between two baffle plates adjacent to each other in the longitudinal direction of the second tubular body and divides a space defined by the two baffle plates.

8. A vacuum die casting apparatus comprising:
a mold;
a vacuum pump;
an intake path through which a cavity of the mold and an intake port of the vacuum pump communicate with each other; and
an oil separating device configured to separate oil from a gas flowing through the intake path, the oil separating device being disposed in the intake path, wherein:
the oil separating device includes a first tubular body and a spiral plate accommodated in the first tubular body; and
the spiral plate and the first tubular body define a spiral flow path in the oil separating device.
